(19) United States
(12) Patent Application Publication
(10) Pub. No.: US 2005/0221841 A1
(43) Pub. Date: Oct. 6, 2005

(54) Location-based control of functions of electronic devices

(76) Inventors: Gregory A. Piccionelli, Westlake Village, CA (US); Michael M. Gerardi, Menifee, CA (US); Ted R. Rittmaster, Westlake Village, CA (US)

Correspondence Address: Greg Piccionelli;Piccionelli & Sarno, Suite 2350, 1925 Century Park East, Los Angeles, CA, 90067, US

(21) Appl. No.: 11/091,972

(22) Filed: Mar. 28, 2005

Related U.S. Application Data
(60) Provisional application No. 60/619,723, filed on Oct. 18, 2004.
(60) Provisional application No. 60/557,939, filed on Mar. 31, 2004.

(51) Int. Cl. H04Q 7/20

(52) U.S. Cl. 455/456.3; 455/456.1

(57) ABSTRACT

A mobile personal communication device, such as a mobile telephone (cellular, satellite, or the like), that is capable of determining its geographic location, through an on-board GPS unit or other geographic locating mechanism, has a function that is disabled, enabled, modified or otherwise controlled when the personal communication device is determined to be within a defined area. The function controlled based on geographic region may include: the transmission of a data stream, such as a video or audio data stream, from or to the personal communication device; the disamblement or modification of ringers or other mechanism for audible notification of an event, for example, an incoming call or message from an external caller; the disablement or modification of an on-board camera or other on-board recording mechanism; and/or the disablement or modification of screen savers, disabling or modification of display lighting or backlighting or other functions of the personal communication device.

### FIELD OF THE INVENTION

The present invention relates to methods, systems and devices for controlling functions of an electronic device, based on geographic location and, in particular embodiments, to the control of functions of personal communication devices, such as a cellular telephones, within defined geographic areas. Particular embodiments of the present invention relate to methods and systems employing a mobile personal communication device, such as a mobile telephone (cellular, satellite, or the like), that is capable of determining its geographic location, such as through an on-board GPS unit or other geographic locating mechanism, and in which a function is disabled, enabled, modified or otherwise controlled when the personal communication device is determined to be within a defined area. The function controlled based on geographic region, in accordance with various aspects of the present invention, may include: the transmission of a data stream, such as a video or audio data stream, from or to the personal communication device; the disamblement or modification of ringers or other mechanism for audible notification of an event, for example, an incoming call or message from an external caller; the disablement or modification of an on-board camera or other on-board recording mechanism; and/or the disablement or modification of screen savers, disabling or modification of display lighting or backlighting or other functions of the personal communication device.

### BACKGROUND OF THE INVENTION

The use of mobile telephones has proliferated since the 1990's until such devices are nearly ubiquitous. The quality and functionality of cellular and satellite telephone service has continually improved, even as the individual telephone units themselves have decreased in size. It is now possible to use a mobile telephone from almost any location in the United States and other industrialized nations. Some modern mobile telephone units include not only the usual voice transmission capability, but can also include display screens and electronics suitable for displaying graphics and videos, Internet communication software, miniaturized digital still or video cameras, global positioning system (GPS) devices, and/or other features that provide functions well beyond voice communication.

However, the constant improvement in mobile telephones has had unanticipated consequences. Mobile telephones including video cameras enable a user of the mobile telephone to produce still or streaming video images of subjects of interest and transmit the images to other telephone users, or even to e-mail addresses, allowing dissemination of the images over the Internet. Because of the mobile and concealable nature of modern mobile telephone units, this technology can be subject to abuse. Unscrupulous users might employ video-capable cellular telephones to transmit video and audio data streams from movie theaters, concert halls, sporting events and the like, potentially infringing the copyrights of the subject performances. Other users might transmit images from private locations or other areas in which people have an expectation of privacy. More ominously, other users might surveil sites such as airports, train stations, power plants, government offices and the like.

Another improvement in modern mobile telephone functions is the capability to play one or more preprogrammed audible indicator, for -example, indicating an incoming telephone call or message from an external source. Some mobile telephone units have one or more programmable audible sequence of tones, notes or chords, simulating a portion of a song or tune, such that user's may cause the units to play audible portions of songs or tunes to indicate the receipt of an incoming telephone call or message. However, users may forget to turn off or otherwise suitably lower the volume on such audible indicators in locations in which the playing of an audible song or tune would be undesireable. For example, in certain locations, such as theaters, concert halls, places of worship, or the like, the playing of an audible song or tune or the sounding of a ringer or other audible indicator of an incoming telephone call or message can be annoying to other people in the vicinity of the user and embarrassing to the user.

A need exists for methods, systems and devices which facilitate the control of functions associated with mobile personal communication devices in locations or areas in which those functions may be undesired (or desired).

### SUMMARY OF THE PREFERRED EMBODIMENTS

In accordance with one aspect of the present invention, there is provided a system, device and a method that controls at least one function of a mobile personal communication device (PCD), such as, but not limited to, a mobile telephone. Further embodiments may be applicable to other PCDs, including, but not limited to personal digital assistants (such as Palm Pilot, Blackberry, or the like), MP3 devices, iPod devices, other digital music receiving and playing devices, digital video or image data receiving devices or the like.

The function or functions controlled based on geographic region, in accordance with various aspects of the present invention, may include: the transmission of data, such as a video or audio data stream, from or to the mobile PCD; the disamblement, enablement or modification of ringers or other mechanisms for audible notification of an event, such as an incoming call or message from an external caller; the disablement, enablement or modification of an on-board camera or other on-board recording mechanism; and/or the disablement, enablement or modification of screen savers, alarms, display lighting or backlighting or other functions of the PCD.

Thus, a method according to embodiments of the present invention includes: defining at least one geographic area; determining the location of a mobile PCD; and controlling at least one function associated with the mobile PCD, dependant upon the determined location.

According to one aspect of the invention, controlling at least one function dependent upon the determined location of the PCD comprises controlling the transmission of data from the mobile PCD when the location of the mobile device is within the defined geographic area. According to another aspect of the invention, controlling at least one function comprises controlling the transmission of data to the mobile device when the location of the mobile device is within the defined geographic area. Such data may include, but is not limited to, video, still image, graphic, text, or audio data, control instructions associated with controlling a function of the mobile PCD, ring tone data, screen saver data, or the like, depending upon the location of the PCD.

According to a further aspect of the invention, controlling at least one function comprises disabling, enabling or modifying a ringer or other mechanism in the personal communication device that audibly notifies a user of the device of an event, depending upon the location of the PCD, where the event may be, for example, an incoming call or message from an external caller.

According to yet a further aspect of the invention, controlling at least one function comprises disabling, enabling or modifying the function of a camera or other recording mechanism in the PCD, depending upon the location of the PCD.

According to yet a further aspect of the invention, controlling at least one function comprises disabling, enabling or modifying at least one screen saver displayable on a display screen on the PCD, depending upon the location of the PCD.

In certain embodiments, the geographic location of the personal communication device is determined from data obtained by a GPS device located in or otherwise associated with the personal communication device. In other embodiments, other suitable mechanisms are employed for determining the location of the personal communication device, including, but not limited to, software and/or hardware systems for determining location by analysis of signals received from fixed locations (such as triangulation and/or signal strength analsys of signals from cell station sites); analysis of network address data associated with local network addresses or local servers in communication with the personal communication device; or the like.

Mobile PCDs are capable of transmitting a variety of data streams, including, for example, video and audio data streams. In some embodiments of the present inventive method, transmission of such data streams is disabled, when the PCD is determined to be within (or, in other embodiments, outside of) one or more predefined geographic areas. In other particular embodiments, transmission of such data streams is modified, when the PCD is determined to be within (or, in other embodiments, outside of) one or more predefined geographic areas. In certain more specific embodiments, the data stream is a video data stream and the resolution of the data stream is reduced when the PCD is determined to be within (or, in other embodiments, outside of) one or more predefined geographic areas. In other more specific embodiments, the data stream is a video data stream and an overlay is superimposed on the data stream when the PCD is determined to be within (or, in other embodiments, outside of) one or more predefined geographic areas. In example embodiments, such an overlay is sufficient to reduce or eliminate the commercial value of recordings of the transmitted video data stream.

In still other more specific embodiments, the data stream is an audio data stream comprising a plurality of frequencies, and at least a portion of the frequencies are filtered when the PCD is determined to be within (or, in other embodiments, outside of) one or more predefined geographic areas. Such a filtration, in such specific embodiments, is sufficient to reduce or eliminate the commercial value of recordings of the transmitted audio data stream.

Control of at least one PCD function, as described above, may be accomplished automatically, according to particular embodiments of the inventive method. In other embodiments, a user of a PCD is given an opportunity to override the automatic control, for example, a mechanism for selecting an option to cause the function control to occur (or, in other embodiments, to not occur).

In further embodiments, the PCD may be controlled to provide the user with a warning prior to an automatic control of a function, to allow a user to take actions to override the control, if override is available and desired, and/or to allow the user to take actions to avoid entering a geographic region in which PDC function control is implemented.

For example, where the controlled function is the receipt or transmission of data communications over a telephone network, a user may be given an opportunity to cease use of a mobile telephone or otherwise control data stream transmission from the mobile telephone prior to entry into the defined geographical area. Thus, according to still other particular embodiments of the inventive method, a distance from a predefined geographic area may be specified, and the user of the mobile personal communication device may be provided with a warning when the mobile communication device is within the specified distance from the geographic area. The warning can include, in very particular embodiments, a request to cease use of the controlled function when the cellular telephone is within the geographic area.

Further particular embodiments of the inventive method include creating a record of the presence of the mobile PCD within the defined geographic area.

Control of the transmission of a data stream from the mobile PCD within the defined geographic area can also be accomplished, in specific embodiments, by use of pattern recognition means, such as voice-recognition circuitry, as well as by limitation of transmission of a data stream to one or more pre-selected telephone numbers.

According to an another aspect of the present invention, there is provided a method for controlling a function of a mobile PCD which includes the steps of: defining a geographic area; determining the location of the PCD; and creating a recording of a data stream transmission from and/or to the PCD when the location of the PCD is within the defined geographic area.

A system for controlling at least one function of a mobile PCD, according to further aspects of the present invention includes: means for defining at least one geographic area; location means for determining the location of the mobile PCD; and control means for controlling at least one function associated with the PCD based on the determined location of the PCD. The function or functions controlled based on the location of the PCD may include any one or combination of functions described above with respect to the method aspects of the invention.

In particular embodiments, means for defining at least one geographic area may comprise software or firmware associated with a processor and memory in the PCD, for storing data identifying at least one geographic area. In further embodiments, means for defining a geographic area may also comprise input means comprising one or more of a keyboard, a disk drive, an input port for receiving input signals from an external device, or the like.

Location means, in specific embodiments, may comprise GPS means, for example a GPS device capable of receiving and/or processing satellite signal data to determine its geographic location. The GPS device may be incorporated directly into the PCD or connected to communicate with the PCD through a connection local to the PCD. In other embodiments, other suitable mechanisms are employed for determining the location of the PCD, including, but not limited to, software, firmware and/or hardware systems, for determining location by analysis of signals received from fixed locations (such as triangulation and/or signal strength analsys of signals from cell station sites); analysis of network address data associated with local network addresses or local servers in communication with the personal communication device; or the like.

Control means, in particular embodiments, comprises software, firmware or hardware associated with the processor in the PCD or other electronic means, such as electronic circuitry, for controlling at least one function of the PCD, based on the location of the PCD. For example, controlling a function may comprise disabling (or enabling) transmission of a video or audio data stream, and/or modifying the quality of the data stream to or from the PCD, based on the location of the PCD (such as, when the PCD is determined to be within at least one pre-defined geographic area or, in other embodiments, when the PCD is determined to be outside of at least one pre-defined geographic area).

In accordance with a further aspect of the present invention, there is provided a method and system of transmitting a data stream to a cellular telephone, the method including the steps of: defining a geographic area; determining the location of a cellular telephone; and transmitting a data stream to the cellular telephone when the location of the cellular telephone is within the defined geographic area.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which:”

FIGS. 1a-1c are generalized block diagrams of system examples of the present invention.

FIGS. 2a-2b are front and side schematics of a PCD according to an embodiment of the present invention, where an example PCD comprises a mobile telephone that includes audio and/or video data stream transmission and reception circuitry, GPS circuitry and circuitry for modifying the transmission of or reception of audio and/or video data streams,

FIGS. 3a-4b illustrate a method according to an embodiment of the invention in which transmission of a video data stream from a mobile PCD is disabled when the PCD enters a defined geographic area, and

FIGS. 5a-5b illustrate a method according to an embodiment of the invention in which the user of a PCD is provided with a warning to disable operation of video transmissions from the PCD when the user approaches a defined geographic area.

Like numerals refer to like parts throughout the several views of the drawings.

### DETAILED DESCRIPTION OF THE PREFERRED EMBODIMENTS

Embodiments of the present invention relate to methods, systems and devices for controlling functions of an electronic device, based on geographic location. Particular embodiments of the invention relate to the control of functions of portable or mobile personal communication devices, such as a cellular telephones, within defined geographic areas. However, other embodiments of the invention involve other types of mobile personal communication devices, including, but not limited to personal digital assistants (such as Palm Pilot, Blackberry or other PDAs), MP3 devices, iPods, other digital audio or video/image receiving and playing devices, or the like.

For example, a mobile personal communication device (PCD), such as a mobile telephone (cellular, satellite, or the like), is provided with hardware, software, or combinations thereof to provide the capability of identifying or determining its geographic location. Further hardware, software or a combination thereof is provided to control a function of the mobile PCD, based on its identified or determined geographic location. For example, controlling a function, based on geographic location, may comprise disabling, enabling, modifying or replacing a function when the personal communication device is determined to be within a defined area. The function controlled based on geographic region, in accordance with various aspects of the present invention, may include: the transmission or reception of a data stream, such as a video or audio data stream, from or to the personal communication device; the disamblement or modification of ringers or other mechanism for audible notification of an event, for example, an incoming call or message from an external caller; the disablement or modification of an on-board camera or other on-board recording mechanism; and/or the disablement or modification of screen savers, display lighting or backlighting or other functions of the personal communication device.

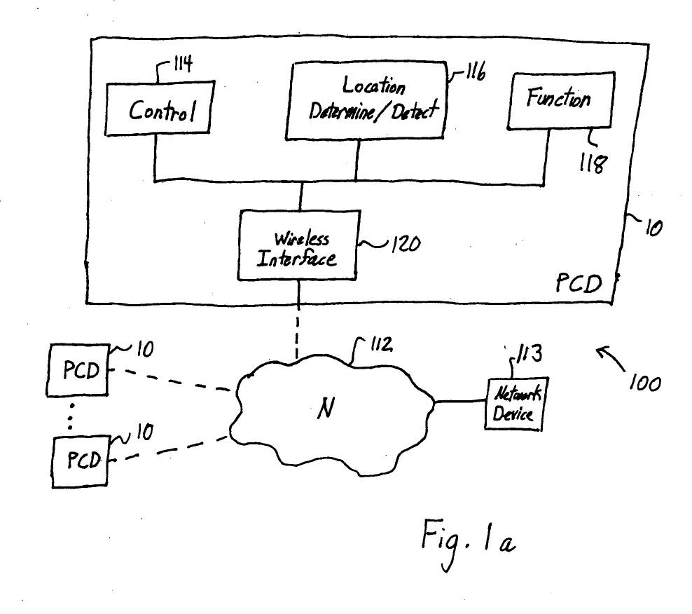

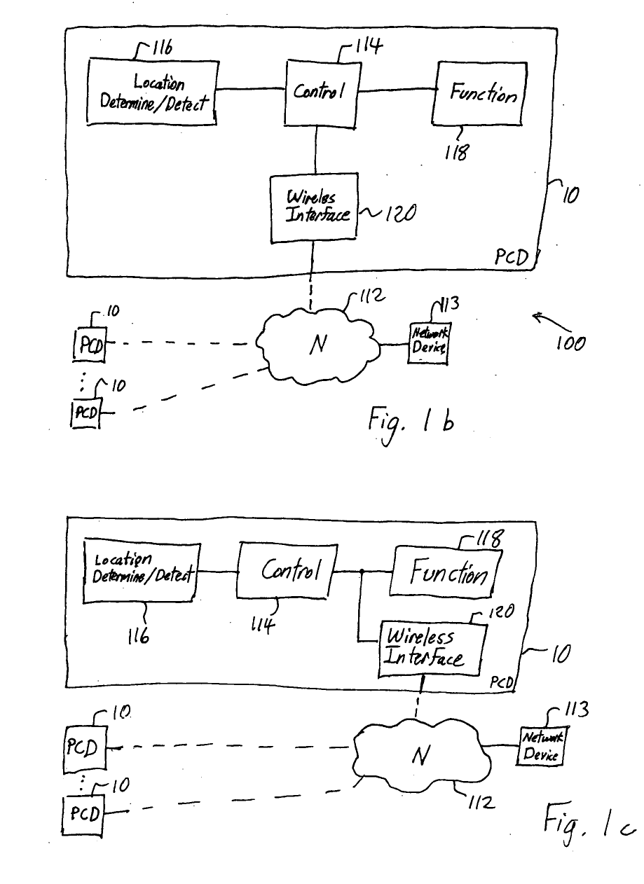

FIGS. 1a, 1b and 1c each show a generalized, functional block diagram of a system 100 according to an embodiment of the invention, where the three drawings represent three respective example configurations. Other embodiments may employ other suitable configurations that allow the system to perform functions as described herein. The system 100 includes one or more portable PCDs 10, each connectable, via a wireless communication link (shown in broken lines), to a communicaton network 112. The PCDs may be operated by individual users for communication with each other and/or with other devices 114 over the network 112.

In some example embodiments, the communication network 112 may include or be connected to the Internet, or other wide area network, to allow the PCDs 10 to receive or send information to other network devices 113. Such other network devices may comprise servers or other communication equipment operated by a telephone company and/or other business or service entites as described below. In some embodiments, the communication network 112 may include a wireless telephone communication network for communication of audio telephone signals or other data signals typically communicated from a common wireless telephone devices. The system in FIG. 1 represents an example of a wireless communication embodiment of the invention.

The PCDs include electronic hardware, software and/or combinations thereof for providing a control function (represented by control block 114), a location determination or detection fuction (block 116) and a controlled function (block 118). The PCDs may also include electronic hardware, software and/or combinations thereof for providing a wireless network interface or network communication function (block 120), for connection to the communication network 112. The PCDs 110 may include other suitable functional components as well known in the art for providing functions described herein. The hardware and/or software stored in memory associated with the function blocks (as described below), may be coupled together in any suitable manner, including, but not limited to, addressable bus architecture or other suitable connection architecture or other manners as represented by the three examples shown in FIGS. 1a, 1b 1c.

The components of each PCD may be encased within a common housing, as represented by the box labeled 10 in FIGS. 1a, 1b and 1c. However, in further embodiments, one or more of the components may be housed in a separate housing from other components and connected to the other components through a local electronic or wireless connection.

In the illustrated embodiment, the control block 114 is connected to receive location information from the location determination or detection block 116. The control block 114 is also connected to provide control information to the controlled function block 118. The control block 114 also may be connected to the wireless network interface 120 and may also be connected to the audio communication block, to provide or control communication of information over the network 112.

The control block 114 may include a processor and associated memory or other suitable electronic circuitry or the like, for processing data and controlling operation of other components, as described herein. Embodiments employing a programmable processor include suitable software, hardware or combinations thereof for controlling the processor to perform functions and otherwise operate in the manner described herein. Other embodiments may employ one or more application specific integrated circuits (ASICs) or other electronics components configured to perform the operations described herein. Yet other embodiments may employ combinations of programmable processors, ASICs, and/or other electronic components configured to perform the operations described herein.

The control block 114 also may include or operate with a user interface, such as, but not limited to one or more display devices (LCD, plasma, CRT or the like) and one or more user input means (input keys, buttons, knobs, touch-responsive panel or screen, microphone and audio processing circuitry, or the like). The user interface allows a user to input information as described below. In mobile telephone embodiments, the user input means may include a microphone or other audio pick-up device and audio processing circuitry for telephone audio communication. In additional embodiments, the user input means may further include voice recognition software, hardware or combinations thereof, for recognizing information input by a user through the microphone.

The location determination or detection block 116 may include hardware, software or combinations thereof, operable with the processor of the control block 114 to provide location information to the processor. Embodiments of the inventive system, method and device can be practiced using a variety of location determination or detection techniques, including, but not limited to GPS systems, software or hardware systems for analyzing address or other location-providing data that is included in data packets communicated over networks such as the Internet, triangulation of signals received from fixed sites, manual entry of location information by the user, or the like. Non-limiting examples of some of such techniques include those described in co-pending U.S. patent applications Ser. Nos. 09/812,296 and 09/647,635, the entire disclosures of each of which are incorporated herein by reference as if fully set forth below, as well as in U.S. Pat. No. 6,154,172 (issued Nov. 22, 2000), the entire disclosure of which is incorporated herein by reference as if fully set forth below.

The function block 118 represents a controllable function of the PCD. According to particular embodiments of the invention, the controllable function block 118 comprises hardware, software or combinations thereof for reception or processing of communication signals by the PCD from the network 112. According to other embodiments of the invention, the controllable function block 118 additionally or alternatively comprises hardware, software or combinations thereof for the transmission, or processing of communication signals for transmission, from the PCD over the neterwork 112. Particular embodiments of the invention may employ audio pick-ups, audio output devices, and audio processing circuitry similar to those currently provided in many modern conventional mobile telephones, however, connected or configured to be controlled by the processor of control block 114, as described herein.

According to yet other embodiments of the invention, the controllable function block comprises hardware, software or combinations thereof for providing an audible notification of an event, for example, but not limited to a ringer, audio generator or other audible indicator of an incoming call or message from an external caller. According to further embodiments of the invention, the controllable function block 118 comprises hardware, software or combinations thereof for providing a non-audible notification of an event. In mobile telephone embodiments, the non-audible notification of an event may comprise, for example, but not limited to a vibrator, a light or other visible, tactile or otherwise non-audible indicator of an incoming call or message from an external caller. Particular embodiments of the invention may employ an audible and/or non-audible notification device similar to those currently provided in many modern conventional mobile telephones, however, connected or configured to be controlled by the processor of control block 114, as described herein.

According to yet other embodiments of the invention, the controllable function block 118 comprises hardware, software or combinations thereof for providing optical, still image and/or video image pick-up, such as, but not limited to a still image camera, a video camera, an array of charge coupled devices CCDs, or other optically sensitive devices, or the like, and suitable recording devices, such as, but not limited to one or more RAM circuits, disk drives (floppy, hard or CD), digital memory sticks or cards or other digital video recording device, video tape recorder, recording film or the like. Particular embodiments of the invention may employ an on-board still and/or video cameras and image memory similar to those currently provided in many modern conventional mobile telephones, however, connected or configured to be controlled by the processor of the control block 114, as described herein.

According to yet other embodiments of the invention, the controllable function block 118 comprises hardware, software or combinations thereof for providing audio recording capabilities, such as, but not limited to one or more digital audio recording chips, disk drives (floppy, hard or CD), audio memory cards, audio tape recorders or other audio recording devices. Particular embodiments of the invention may employ one or more on-board audio memory chips or circuits similar to those currently provided in many modern conventional mobile telephones, however, connected or configured to be controlled by the processor of the control block 114, as described herein.

According to yet other embodiments of the invention, the controllable function block 118 comprises hardware, software of combinations thereof for providing a screen saver on a display device associated with the PCD. Particular embodiments of the invention may employ an on-board display device similar to those currently provided in many modern conventional mobile telephones, however, controlled by the processor of the control block 114 to display a screen saver, as described herein.

According to yet other embodiments of the invention, the controllable function block 118 comprises hardware, software of combinations thereof for playing pre-recorded audio, image and/or video information to the user, for example, on a speaker, headphones or other audible sound producing device or on an electronic image or video display device within or otherwise associated with the PCD. Particular embodiments of the invention may employ an on-board memory, speakers, audio output ports, and display devices similar to those currently provided in many modern conventional mobile telephones, however, controlled by the processor of the control block 114 to play recorded audio, image and/or video information to the user, as described herein.

According to yet other embodiments of the invention, the controlled function block 118 comprises one or more other suitable functions associated with or otherwise provided with the PCD, including, but not limited to, lighting of the electronic display, backlighting of the display, or the like. In yet further embodiments, the controlled function block 118 may comprise combinations of two or more of the above-described function block embodiments.

The wireless network interface block 120 may include hardware, software or combinations thereof, operable with the processor of the control block 114 to allow the PCD to connect for communication over the network 112. Particular embodiments of the invention may employ wireless interface components similar to those currently provided in many modern conventional mobile telephones, or other wireless network devices.

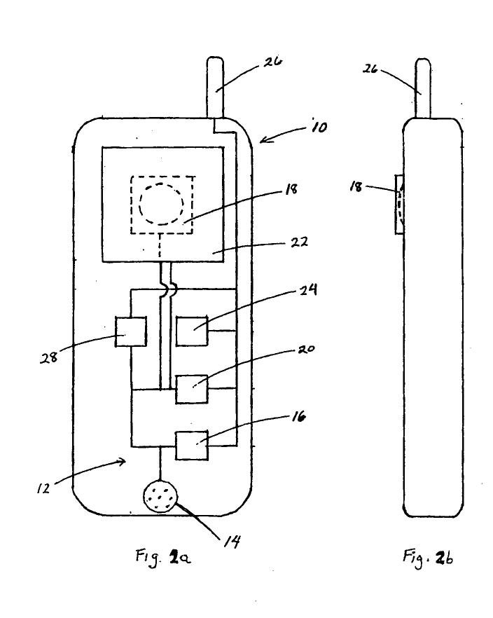

A representative example of a PCD 10 in the form of a mobile (cellular or satellite) telephone is described with reference to FIGS. 2a and 2b. However, other example mobile telephone configurations may be employed within the scope of the invention. The mobile telephone PCD 10 in FIGS. 2a and 2b includes functional components, such as data stream transmission means 12, for example audio pickup 14 in communication with audio transmission circuitry 16 (e.g., a transmitter/receiver), and video camera 18 in communication with video transmission circuitry 20. Screen 22 displays textual, graphic and/or video images.

Location determination/detection components, such as GPS circuitry 24 facilitates determination of the location of the mobile telephone, and is in communication with antenna 26, as are data stream transmission means 12. Control components, such as data stream transmission control circuitry 28 are in communication with data stream transmission means 12 and GPS circuitry 24. Mobile telephone PCD 10 receives signals from a GPS satellite 30 (see FIG. 2a), enabling determination of the GPS coordinates of the cellular telephone.

As applied herein to transmisison of a data stream, the term “control” indicates that the data stream transmission is modified, interrupted or blocked, in whole or in part, or replaced by other data, as opposed to transmission of the data stream as it is produced by the mobile telephone and without any modification, interruption or blockage.

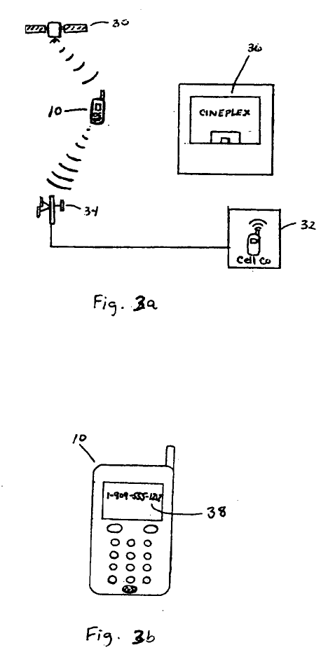

Particular embodiments of the present invention may be useful in practicing methods according to the invention, such as the exemplary method illustrated in FIGS. 3a-b and 4a-c. A PCD 10 receives geographic location information, as illustrated GPS coordinates from GPS satellite 30. In some embodiments, the PCD may, in turn relay location information to telephone company 32 (or other suitable entity conducting a business or service associated with the processes described herein) via tower 34, satellite link or other suitable wireless link. In other embodiments, the PCD may be preprogrammed to provide certain functions associated with the detected geographic location, without forwarding location information to the the telephone company 32 (or other buisiness or service entity).

In some example embodiments, location information for defined geographic area 18 (e.g., GPS coordinates) has been previously supplied to telephone company 32 (or other business or service entity), for example, by the owner of a movie theater, sports stadium, health club or other location, or by a governmental agency. In particular embodiments, the data is supplied by accessing a web site operated by the telephone company 32 (or other business or service entity) and entering the GPS coordinates of the location for which protection is desired. The data can also be supplied by providing a storage device such as a floppy disk to the telephone company 32 (or other business or service entity), verbally by direct contact with the telephone company (or other entity), or any other suitable means. Embodiments of the inventive methods thus afford telephone companies 32 (or other business or service entities) with additional profit potential through assessment of a fee or other premium from those desiring to protect specific locations and/or provide, inhibit or modify services in specific locations (such as owners or operators of businesses located in pre-defined geographic areas 36).

In FIG. 3a, PCD 10 is located outside defined geographic area 36, which can be, for example, a movie theater, a sports stadium, a concert hall, or any other location from which it is desired to control the transmission of a data stream via a PCD. According to some embodiments of the invention, while PCD 10 is located outside defined geographic area 18, the PCD functions may be controlled to operate normally, for example, transmitting a data stream over a communication network (e.g., network 112 in FIGS. 1a, 1b and 1c), which can be, for example, an audio data stream, a video data stream, a data stream encoding a photographic image or a text message, combinations thereof, etc. As shown in FIG. 2b, the PCD provides a user with an indication that it is operational (as shown, a display of the telephone number with which the PCD is currently in contact).

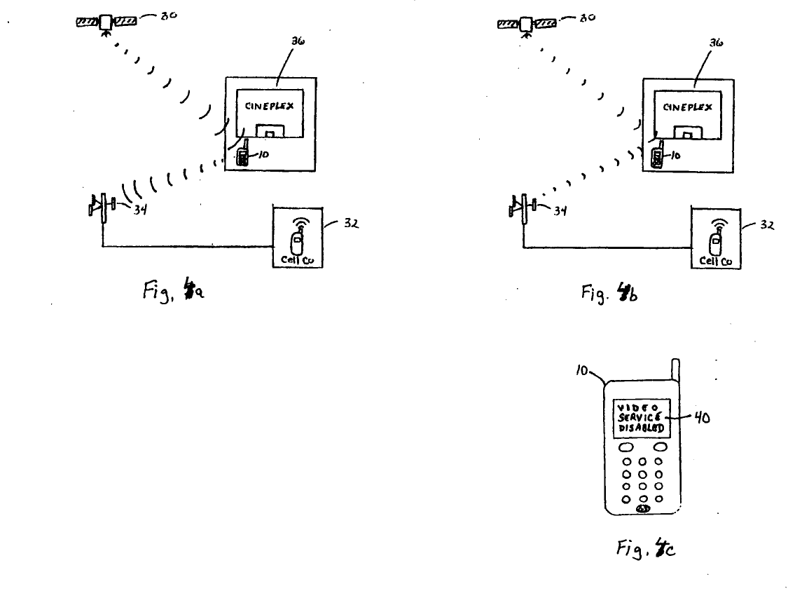

In FIG. 4a, PCD 10 has entered defined geographic area 36 as determined, e.g., by its GPS coordinates. Telephone company 32 (or other business or service entity) receives the GPS coordinates (or other location information) from the PCD 10 (for example, over communication network 112 in FIGS. 1a, 1b and 1c), and is thus alerted to the presence of the PCD within defined geographic area 36. For example, the PCD 10 may be programmed or otherwise configured to automatically transmit location information to the telephone company 32 (or other business or service entity) upon entering (or within a predetermined distance before or after entering) a predefined geographic area.

As represented by FIG. 4b, telephone company 32 (or other business or service entity) then transmits a signal to PCD 10 over the communication network (e.g., network 112 in FIGS. 1a, 1b and 1c) which activates control functions in the PCD (e.g., control function block 114 or control circuitry 28), thereby controlling the transmission of a data stream from the PCD.

Control of a data stream transmission from the PCD can be performed in any suitable manner, including, but not limited to the processor of the control function block controlling hardware and/or software critical to the transmission of data from the PCD. Thus, in the embodiment illustrated in FIG. 4c, transmission of a video data stream from PCD 10 is disabled when the PCD is located within defined geographic area 36. In additional embodiments, transmission of an audio data stream is disabled. The PCD 10 may be controlled to display a message indicating that the function has been disabled.

Alternative embodiments of the inventive method permit transmission of a data stream from within the defined geographic area 36, but modify the transmission in order to reduce or eliminate the value of the transmission in the event a party receiving the transmission should attempt to record the transmission and subsequently distribute and/or commercialize the recording. Thus, in particular embodiments in which a video data stream is transmitted from the PCD 10, data stream transmission control circuitry 28 within PCD 10 adds an overlay to the video data stream, for example an animated icon, a scrolling display, or other graphics which are suitable to obscure all or at least a portion of the video transmission. Analogous modification of an audio data stream can include, for example, the addition of a tone or tones, noise or other audio information to the audio data stream. In other particular embodiments, the control circuitry reduces the quality of the transmitted data stream. Thus, the resolution of a video data stream is reduced in certain embodiments of the inventive method. In other embodiments, the quality of an audio data stream is reduced. For example, in an audio data stream that comprises a plurality of audio frequencies, at least a portion of the audio frequencies are filtered out, replaced or otherwise modified from the transmitted data stream.

Transmission of data streams from PCD 10, more particularly audio data streams including a vocal component, can also be controlled by use of pattern recognition means. In such embodiments, data stream transmission control circuitry 28 within PCD 10 includes pattern recognition circuitry and/or software. When a user attempts to transmit an audio data stream including a vocal component, the user's voice pattern is recognized. The user's words are then used to produce a synthesized version of the words. This synthesized version is then transmitted from the defined geographic area, without transmission of the original audio data stream.

In other embodiments of the inventive method, it may be desirable to permit transmissions from a defined geographic area by means of a PCD, but to limit such transmissions only to (or control such transmissions to be directed to) authorized receiving telephone numbers, such as local police or fire stations, emergency assistance, or other authorized entities engaged in monitoring transmissions from such defined geographic areas, etc. Thus, according to additional embodiments of the inventive method, a database including at least one telephone number is provided to telephone company 32 (or other business or service entity). Once PCD 10 is located within defined geographic location 36, telephone company 32 (or other business or service entity) allows unmodified (uncontrolled) transmissions of data streams from the PCD only to telephone numbers included in the database, or controls the transmission of data streams to other telephone numbers in a manner described above.

Control of data stream transmissions from cellular telephones located within the defined geographic area can be carried out automatically. Alternatively, a user of the PCD can be afforded the opportunity to control such transmissions himself, for example by deactivating the PCD, disabling audio or video transmission from the PCD, etc.

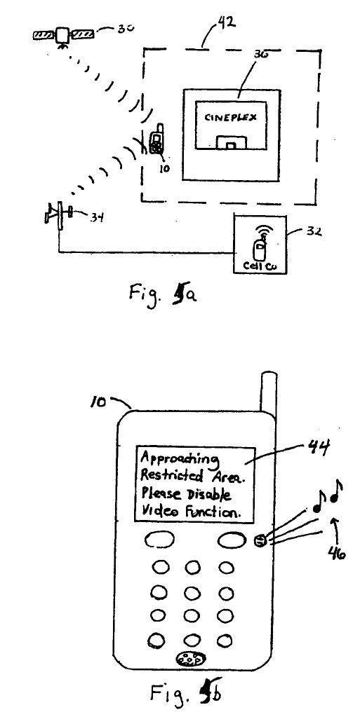

In the exemplary method illustrated in FIGS. 5a-b, a perimeter 42 is defined around defined geographic location 36. When PCD 10 enters the area between perimeter 42 and defined geographic area 36, telephone company 32 (or other business or service entity) transmits to the PCD data for providing to the PCD's user a warning that he is approaching an area, in which cellular telephone use is controlled. Such a warning can include, for example, a warning message 44 appearing on a display screen 22 of the PCD 10, an audio warning 46 generated by a speaker or other sound generating device in the PCD, a tactile warning such as an electronic vibrator in the PCD, etc. The user is then given the opportunity to control the use of the PCD. For example, the user may operate manual controls on the PCD to disable or modify transmission functions as described above. Such embodiments may be userful, for example, in contexts in which the user's voluntary control of data transmission functions is employed, such as, where automatic control of such functions would be forbidden or undesireable due to legal, social, contractual or other factors.

In further specific embodiments, data stream transmission from the PCD may be automatically controlled by the telephone company 32 (or other business or service entity), as described above, in the event that the user fails to heed the warning so provided and enters the defined geographic location 36 without disabling or otherwise controlling data stream transmission from the cellular telephone.

Other alternative methods according to the invention further provide for creating a record of the presence of the PCD within the defined geographic location or locations. Such methods can combine the data stream transmission control functions described above with the recording function. For example, an on-board data recording device may be controlled to record all or portions of data transmissions occurring from the PCD, when the PCD is located with the predefined geographic location or locations. In yet further embodiments, when the PCD is located with the precdefined geographic location or locations, transmissions of data streams from the PCD are automatically directed to a telephone number or network address of a predefined entity (such as the telephone company 32 or other business or service entity) and recorded by the predefined entity. Other methods can omit the data stream transmission control functions but include the recording function. Still other alternative methods according to the invention provide for creating a recording of any data stream transmissions from the PCD within the defined geographic location. Again, these alternative methods can include both data stream transmission control functions and recording functions, or can omit the control function and include only the recording function. These methods are useful, for example, in identifying users who attempt to transmit data streams from protected locations.

The foregoing embodiments illustrate methods of disabling or restricting the transmission of a data stream from a PCD when the PCD enters a defined geographic location. Alternative methods according to the invention conversely provide for activation of a PCD (such as a mobile telephone or other PCD as described above) and transmission of a data stream to the PCD when the PCD enters the defined geographic location.

According to particular embodiments, a PCD user joins an organization with which a first entity (e.g., a commercial or noncommercial entity such as, but not limited to, a department store, amusement park, sports stadium, school, place of worship, etc.) is affiliated. The PCD user and first entity can both be served by a common telephone company 32 (or second business or service entity); alternatively, the PCD user and the first entity can be served by different telephone companies 32 (or second business or service entities) which have a service agreement between them enabling the second entity to transmit information to the PCD user as described herein. A premium (such as a one-time or periodic charge to a bank or credit account, an agreement to join another organization, etc.) can be charged by the second entity to the PCD user and/or the first entity in order to join the organization; and/or, a premium can be provided by the first entity to a PCD user who joins the organization.

Once the PCD user has joined the organization with which the first entity is affiliated, the location of the PCD (e.g., GPS coordinates) is determined as previously described. Once the PCD comes within a defined range of the target location (i.e., the location of a store, building, campus, park or other defined geographic region associated with the first entity), the PCD reception circuitry is activated and a data stream is transmitted to the PCD.

The PCD may be activated automatically. For example, circuitry within the PCD may control the processor of the control block 114 (FIG. 1) lo periodically check the current location of the PCD, for example, by periodically activating an associated GPS system or other location determining or detecting system. The PCD processor may be further controlled to compare the current PCD location with prestored location information (such as a prestored table, list or other arrangement of target locations). Alternatively, or in addition, the PCD processor may be controlled to cause the PCD to transmit its location information to a predefined entity (e.g., first or second entity above) on the network 112, where the predefined entity compares the current PCD location with prestored target locations. If the comparison shows that the PCD is within the target location (or within a predefined range of the target location), the PCD processor may be controlled to activate the PCD reception circuitry (for example, to place the mobile telephone into reception mode, whereby incoming calls may be received). If the comparison is conducted by the predefined network entity, then that entity may communicate a signal to the PCD, e.g., over the network 112, to cause the PCD to activate the PCD reception circuitry. If the comparison is conducted by the PCT processor, then the PCD processor may be programmed to activate the PCD reception circuitry, based on the comparison.

The data stream transmitted to the PCD upon activation of the PCD can be an audio data stream, such as a recorded announcement advising the PCD user of one or more sales occurring at the target location; a video data stream; a data stream including an image, such as an advertisement for a sale item; a data stream including a telephone ring tone; or any other data stream capable of being transmitted to and received by a PCD.

The data stream can be transmitted to the PCD by the telephone company 32 (or second business or service entity), which has previously been provided with the data stream by the first entity. Alternatively, when the PCD enters within the defined range of the target location, the telephone company 32 (or other second business or service entity) can provide the first entity with notification thereof, and subsequently the first entity can transmit the data stream to the PCD user, for example, via the wireless communication network. In the latter alternative, the data stream can be a recorded, data stream, or a live operator can directly call or email or otherwise contact the PCD and personally provide audio information (e.g., to a user answering the call, or to a voice mailbox or email box accessible by the PCD user).

The data stream can be transmitted to the PCD and thus to the PCD user in a variety of ways. For example, in embodiments in which the PCD comprises a mobile telephone, the telephone number for the mobile telephone can be called and the user directly provided with audio and/or visual information about sales, specials, etc., in recorded form or personally by a live operator. Alternatively, the mobile telephone is called and a message is left with the user's voice mailbox email box or other message recording location accessible by the PCD user. In other alternatives, the information contained in the data stream can be loaded into a buffer within the PCD, such as, but not limited to, screen saver storage space, wallpaper storage space, ring tone storage space, etc.

In particular embodiments, the information included in the data stream can be accessed by the PCD user immediately upon entry into the defined range (e.g., upon entry into a building, campus, stadium, park or other location associated with the first entity). In further particular embodiments, a data stream is transmitted to the PCD and the PCD is activated when the PCD approaches within a defined range of a particular site, for example the site of a sale item, within the commercial establishement. This data stream can be transmitted to the PCD when the user initially enters within the defined range of a building, mall, or other location associated with a commercial establishment, and provided to the user when the user approaches the sale item (the PCD's location again being determined by GPS or other means described above); that is, the PCD can be activated when the user approaches the sale item and the previously transmitted data stream can then be displayed or otherwise made available to the user. Alternatively, a second data stream specific to the sale item can be transmitted once the user approaches the sale item.

In another variant method according to further embodiments of the invention, the data stream is transmitted to the PCD, but the PCD is only activated if the PCD leaves the location associated with the first entity (for example, if the PCD leaves a store department, store or mall associated with a commercial establishment without approaching the sale item). For example, the location of the PCD is determined periodically and compared with the location of a sale item in a commercial establishment. If the user fails to approach within a predetermined range of the site of sale item and subsequently leaves the commercial establishment, the PCD is activated and the user is provided with a sale reminder message, more particularly together with the information included in the original data stream.

In order to further motivate PCD users to join the organization with which the commercial establishment is affiliated, specific embodiments of the inventive method provide for entry of the user's mobile telephone number or network address in a lottery. When the PCD enters within the defined range of the target location (the commercial establishment), the number or address of the PCD is provided to the commercial establishment and subsequently entered in a lottery or other contest. Subsequently, the commercial establishment selects one or more winning mobile telephone numbers or network addresses. If the user's number or address is selected, a data stream is transmitted to the user's PCD advising the user that he or she is a winner. In more specific embodiments, a special ring tone is transmitted to the user's mobile telephone and loaded into the telephone's ring tone storage space. In the event that the user is selected, the special ring tone is activated, alerting both the user and neighboring customers that the user has won the lottery.

In various examples discussed above, controlled functions of the PCD comprise transmission and reception of data, such as data streams, based on the geographic location of the PCD. In other examples discussed above, other functions of the PCD may be similarly controlled based on the geographic location of the PCD.

For example, where the controlled function comprises an audible notification of an event, such as, but not limited to a ringer, audio generator or other audible indicator of an incoming call or message from an external caller, the processor of the control block 114 (FIG. 1) may be programmed or otherwise configured to disable the audible indicator upon the PCD entering a predefined geographic region (or a range associated with the predefined geographic region). Alternatively, the processor may be configured to modify the audible indicator (e.g., produce the audible indicator, but with a reduced volume level, partially muted, or for a reduced time relative to unmodified audible indicator), or replace the audible indicator with a different audible indicator (such as a predefined audible ring tone different from the ring tone of the replaced audible indicator) or visual or tactile indicator (such as a light, vibrator or the like), upon the PCD entering a predefined geographic region (or a range associated with the predefined geographic region).

Where the controlled function comprises a non-audible notification of an event, for example, but not limited to a vibrator, a light or other visible, tactile or otherwise non-audible indicator of an incoming call or message from an external caller, the processor of the control block 114 (FIG. 1) may be programmed or otherwise configured to disable the non-audible indicator upon the PCD entering a predefined geographic region (or a range associated with the predefined geographic region). Alternatively, the processor may be configured to modify or replace the non-audible indicator (e.g., produce an audible indicator), upon the PCD entering a predefined geographic region (or a range associated with the predefined geographic region).

Where the controlled function comprises pick-up and recording of optical, still image and/or video image, the processor of the control block 114 (FIG. 1) may be programmed or otherwise configured to disable pick-up and/or recording systems onboard or otherwise associated with the PCD, such as disabling a still image camera, a video camera, an array of charge coupled devices CCDs, or other optically sensitive devices, or the like, and/or RAM circuits, disk drives (floppy, hard or CD), digital memory sticks or cards or other recording devices, onboard or otherwise associated with the PCD upon the PCD entering a predefined geographic region (or a range associated with the predefined geographic region). Alternatively, the processor may be configured to modify or replace images picked up and/or recorded with the onboard or associated pick-up and recording systems.

Where the controlled function comprises audio recording, the processor of the control block 114 (FIG. 1) may be programmed or otherwise configured to disable audio recording chips, disk drives (floppy, hard or CD), audio memory cards, audio tape recorders or other audio recording devices onboard or otherwise associated with the PCD, based upon the geographic location of the PCD. In yet further embodiments described above, the processor may be programmed or configured to enable and cause recording, based on the geographic location of the PCD.

Where the controlled function comprises providing a screen saver on a display device associated with the PCD, the processor of the control block 114 (FIG. 1) may be programmed or otherwise configured to retrieve a predefined, pre-stored screen saver program and cause the a screen saver image (or set of images) associated with that screen saver program to be displayed based on the geographic location of the PCD. Thus, a particular screen saver program may be activated upon the PCD entering a predefined region (or range associated with the predefined region) and/or upon the PCD exiting a predefined region (or range). The predefined, prestored screen saver program may have been previously provided to the user of the PCD, for example, in a previous network communication session with a network device (e.g., device 113 associated with the first or second entity described above), from a computer readable disk or other storage medium provided to the user or otherwise prestored on the user's PCD. In further embodiments, the predefined screen saver may be supplied to the user's PCD as or upon the user entering the predefined region (or range associated with the predefined region), for example, from a network connection established with the PCD by the network device 113 (such as the first or second entity discussed above). In this manner, as a user enters a geographic region (such as a building, campus, stadium, park or other region associated with a commercial establishment or other entity), the user may be provided with a screen saver associated with that entity (e.g, a famous cartoon screen saver when the PCD is located in an amusement park or a sport's team's emblem screen saver when the PCD is located in a sports park or stadium). Similar processor controls may be carried out for providing a wallpaper program for displaying a predefined wallpaper on the display of the PCD, based on the location of the PCD.

Where the controlled function comprises playing pre-recorded audio, image and/or video information to the user, the processor of the control block 114 (FIG. 1) may be programmed or otherwise configured to disable or enable and activate a speaker, headphones or other audible sound producing device or on an electronic image or video display device or audio or image memory within or otherwise associated with the PCD, based on the location of the PCD.

Where the controlled function comprises other suitable functions associated with or otherwise provided with the PCD, including, but not limited to, lighting of the electronic display, the processor of the control block 114 (FIG. 1) may be programmed or otherwise configured to disable circuits or software associated with such functions or to modify such functions, for example, to lower the intensity of the light, based on the location of the PCD. Thus, for example, if the PCD is within a predefined region, the display light intensity may be lowered.

Each of the functions described in the above embodiments may be controlled to be disabled, enabled or modified, upon the PCD entrieng a predefined region (or a range associated with a predefined region), depending upon the embodiment of the invenition. Also, each of the applicable variations described above with respect to the functions of transmission or reception of data by the PCD, based on geographic location, may be employed in connection with the control of other functions.

While embodiments of the invention described above refer to PCDs, including mobile telephones, various aspects of embodiments of the invention are also applicable to portable telephone (or other communication device) handsets that communicate with base stations. Thus, for example, in a manner similar to that described above for the mobile telephone, a portable telephone handset may be controlled to disable a ringer or other functions (or to enable or modify functions as described above), upon the portable telephone handset entering a particular room of a house or facility (e.g., disable the ringer when entering the nursery).

Also, while above embodiments describe aspects of the invention in connection with a mobile PCD, other embodiments of the invention are applicable with other types of electronic devices, including but not limited to electronic digital cameras, electronic audio recording devices, medical devices, electronic games, or the like. Thus, further embodiments of the invention are applicable to controlling functions associated with such other electronic devices.

Furthermore, while embodiments of the invention described above employ GPS or other forms of location determination and detection associated with the PCD, other embodiments may employ further devices associated with first entity 36. For example, one or more wireless transmitting devices located in or near a geographic region associated with the first entity (e.g., location of the store, campus, stadium, park or other region), may be provided for transmitting location information or other suitable signals to the PCD, upon the PCD entering or nearing the region. The PCD may include suitable detection circuitry for detecting the transmitted signal and the PCD's processor may be programmed or configured to control functions as described above, based on the a determination that the PCD is within a predefined geographic region from the receipt of the transmitted signal.

1. A method of controlling a function of a personal communication device, the method comprising the steps of:
defining a geographic region,
determining the location of a personal communication device, and
modifying an operation of the function of the personal communication device upon the personal communication device being determined to be within the defined geographic region.

2. The method of claim 1 wherein modifying an operation of the function of the personal communication device comprises turning off the operation of a function upon the personal communication device being determined to be within the defined geographic region.

3. The method of claim 1 wherein modifying an operation of the function of the personal communication device comprises turning on the operation of a function upon the personal communication device being determined to be within the defined geographic region.

4. The method of claim 1 wherein the controlled function of the personal communication device comprises an audio indicator of an incoming telephone call and wherein modifying an operation of the function of the personal communication device comprises causing the audio indicator of the personal communication device to produce predefined audio content upon the personal communication device receiving an incoming telephone call while being within the defined geographic region.

5. The method of claim 1 wherein the controlled function of the personal communication device comprises an audio indicator of an incoming message and wherein modifying an operation of the function of the personal communication device comprises causing the audio indicator of the personal communication device to produce predefined audio content upon the personal communication device receiving an incoming message while being within the defined geographic region.

6. The method of claim 1 wherein the controlled function of the personal communication device comprises an electronic indicator for indicating the occurance of a predefined event and wherein modifying an operation of the function of the personal communication device comprises causing the electronic indicator of the personal communication device to provide a predefined indication action upon the occurance of a predefined event while being within the defined geographic region.

7. The method of claim 6 wherein causing the personal communication device to provide a predefined indication action comprises at least one of providing a tactile indication signal, providing an audible indication signal and providing a visual indication signal.

8. The method of claim 1 wherein the controlled function of the personal communication device comprises a camera function for recording image information and wherein modifying an operation of the function of the personal communication device comprises disabling the camera function upon the personal communication device being determined to be within the defined geographic region.

9. The method of claim 1 wherein the controlled function of the personal communication device comprises a screen lighting function for lighting a visual display and wherein modifying an operation of the function of the personal communication device comprises at least one of disabling the screen lighting function or reducing the intensity of light produced by the screen lighting function upon the personal communication device being determined to be within the defined geographic region.

10. The method of claim 1 wherein the controlled function of the personal communication device comprises a visual screen saver display function and wherein modifying an operation of the function of the personal communication device comprises controlling the personal communication device to provide a predefined screen saver display upon the personal communication device being determined to be within the defined geographic region.

11. A system for controlling a function of a personal communication device, the system comprising:
means for determining the location of a personal communication device, and
means for modifying an operation of the function of the personal communication device upon the personal communication device being determined to be within a defined geographic region.

12. The system of claim 11 wherein modifying an operation of the function of the personal communication device comprises one of turning on or turning off the operation of a function upon the personal communication device being determined to be within the defined geographic region.

13. The system of claim 11 wherein the controlled function of the personal communication device comprises an audio indicator of an incoming message and wherein modifying an operation of the function of the personal communication device comprises causing the audio indicator of the personal communication device to produce predefined audio content upon the personal communication device receiving an incoming message while being within the defined geographic region.

14. The system of claim 11 wherein the controlled function of the personal communication device comprises an electronic indicator for indicating the occurance of a predefined event and wherein modifying an operation of the function of the personal communication device comprises causing the electronic indicator of the personal communication device to provide a predefined indication action upon the occurance of a predefined event while being within the defined geographic region.

15. The system of claim 11 wherein the controlled function of the personal communication device comprises a camera function for recording image information and wherein modifying an operation of the function of the personal communication device comprises disabling the camera function upon the personal communication device being determined to be within the defined geographic region.

16. The system of claim 11 wherein the controlled function of the personal communication device comprises a recording function for recording at least one of audio and image information and wherein modifying an operation of the function of the personal communication device comprises disabling the recording function upon the personal communication device being determined to be within the defined geographic region.

17. The system of claim 11 wherein the controlled function of the personal communication device comprises a screen lighting function for lighting a visual display and wherein modifying an operation of the function of the personal communication device comprises at least one of disabling the screen lighting function or reducing the intensity of light produced by the screen lighting function upon the personal communication device being determined to be within the defined geographic region.

18. The system of claim 11 wherein the controlled function of the personal communication device comprises a visual screen saver display function and wherein modifying an operation of the function of the personal communication device comprises controlling the personal communication device to provide a predefined screen saver display upon the personal communication device being determined to be within the defined geographic region.

19. A method of transmitting a data stream to a cellular telephone, the method comprising the steps of:
a) defining a geographic area,
b) determining the location of a cellular telephone, and
c) transmitting a data stream to the cellular telephone when the location of the cellular telephone is within the defined geographic area.

20. The method of claim 19 wherein the data stream comprises a cellular telephone ring tone.

21. The method of claim 19 wherein a database comprising at least one telephone number is provided and wherein in step c) the data stream is transmitted when the telephone number of the cellular telephone is included in the database.
